(19) United States
(12) Patent Application Publication
(10) Pub. No.: US 2026/0161727 A1
(43) Pub. Date: Jun. 11, 2026

(54) INFORMATION PROCESSING SYSTEM, ARRAY SPLITTING DEVICE, AND ARRAY COMBINING DEVICE

(71) Applicant: NEC Corporation, Tokyo (JP)

(72) Inventor: Akihiro YATABE, Tokyo (JP)

(73) Assignee: NEC Corporation, Tokyo (JP)

(21) Appl. No.: 19/399,986

(22) Filed: Nov. 25, 2025

(30) Foreign Application Priority Data
Dec. 10, 2024 (JP) 2024-215017

(51) Int. Cl. G06F 17/11; G06F 17/16

(52) U.S. Cl. CPC G06F 17/11; G06F 17/16

(57) ABSTRACT

The client includes a splitting unit that, for each element of an input array whose elements are numbers, generates an array obtained by splitting off a numeric component that represents the most significant digit of the number and transmits the array to the server, and then repeats processing in which, for a number remaining for each element after subtracting, from the numbers of the array before splitting, the numbers of the split array element by element, the splitting unit generates an array obtained by splitting off a numeric component that represents the most significant digit of the remaining number and transmits the array to the server. The server includes a combining unit that, each time an array is received from the client, performs calculation processing using a new array generated by combining, element by element, the numbers of the received array with those of a stored array.

### CROSS-REFERENCE TO RELATED APPLICATIONS

This application is based upon and claims the benefit of priority from the prior Japanese Patent Application No. 2024-215017, filed Dec. 10, 2024, the entire contents of which are incorporated herein by reference.

### BACKGROUND OF THE INVENTION

The present disclosure relates to an information processing system and an information processing method that causes another computer to execute processing, and an array splitting device, an array combining device, an array splitting program, and an array combining program.

System configurations in which processing is caused to be executed by another device via a communication network are widely known. For example, Patent Literature 1 discloses a system in which an information processing device requests a server to execute processing via a communication network. In the system described in Patent Literature 1, the data size of a QUBO model that is the processing target of the server is compared with the data size of a program representing the QUBO model, and the one having the smaller data size is transmitted to the server.

### PRIOR ART DOCUMENTS

### Patent Literatures

[Patent Literature 1] Japanese Patent No. 7464136

### SUMMARY OF THE INVENTION

For example, even in a system as described in Patent Literature 1 where the QUBO model is selected as the transmission target and a large-scale QUBO model is handled, it is preferable to be able to shorten the data transmission time.

Accordingly, an example object of the disclosure to provide an information processing system, an array splitting device, an array combining device, an information processing method, an array splitting program, and an array combining program that can shorten the transmission time of data for causing another computer to execute processing.

The information processing system according to the present disclosure includes a client that issues an execution instruction to another computer, and a server that receives the execution instruction from the client, wherein the client includes a splitting unit that, for each element of an input array whose elements are numbers, generates an array obtained by splitting off a numeric component that represents the most significant digit of the number and transmits the array to the server, and then repeats processing in which, for a number remaining for each element after subtracting, from the numbers of the array before splitting, the numbers of the split array element by element, the splitting unit generates an array obtained by splitting off a numeric component that represents the most significant digit of the remaining number and transmits the array to the server, and wherein the server includes a combining unit that, each time an array is received from the client, performs calculation processing using a new array generated by combining, element by element, the numbers of the received array with those of a stored array.

The array splitting device according to the present disclosure includes a transceiver unit that performs transmission and reception with a server that, each time an array whose elements are numbers is received, performs calculation processing using a new array generated by combining, element by element, the numbers of the received array with those of a stored array, and a splitting unit that, for each element of an input array whose elements are numbers, generates an array obtained by splitting off a numeric component that represents the most significant digit of the number and transmits the array to the server, and then repeats processing in which, for a number remaining for each element after subtracting, from the numbers of the array before splitting, the numbers of the split array element by element, the splitting unit generates an array obtained by splitting off a numeric component that represents the most significant digit of the remaining number and transmits the array to the server.

The array combining device according to the present disclosure includes a transceiver unit that performs transmission and reception with a client that, for each element of an input array whose elements are numbers, generates and transmits an array obtained by splitting off a numeric component that represents the most significant digit of the number, and a combining unit that, each time an array is received from the client, performs calculation processing using a new array generated by combining, element by element, the numbers of the received array with those of a stored array, wherein the client repeats processing in which, for a number remaining for each element after subtracting, from the numbers of the array before splitting, the numbers of the split array element by element, the client generates an array obtained by splitting off a numeric component that represents the most significant digit of the remaining number and transmits the array.

The information processing method according to the present disclosure includes a client, which issues an execution instruction to another computer, generating, for each element of an input array whose elements are numbers, an array obtained by splitting off a numeric component that represents the most significant digit of the number and transmitting the array to a server, the server, each time an array is received from the client, performing a calculation using a new array generated by combining, element by element, the numbers of the received array with those of a stored array; and the client repeating processing in which, for a number remaining for each element after subtracting, from the numbers of the array before splitting, the numbers of the split array element by element, generating an array obtained by splitting off a numeric component that represents the most significant digit of the remaining number and transmits the array to the server.

The array splitting program according to the present disclosure causes a computer to execute a transceiver process with a server that, each time an array whose elements are numbers is received, performs calculation processing using a new array generated by combining, element by element, the numbers of the received array with those of a stored array, and a splitting process that, for each element of an input array whose elements are numbers, generates an array obtained by splitting off a numeric component that represents the most significant digit of the number and transmits the array to the server, and then repeats processing in which, for a number remaining for each element after subtracting, from the numbers of the array before splitting, the numbers of the split array element by element, and that generates an array obtained by splitting off a numeric component that represents the most significant digit of the remaining number and transmits the array to the server.

The array combining program according to the present disclosure causes a computer to execute a transceiver process with a client that, for each element of an input array whose elements are numbers, generates and transmits an array obtained by splitting off a numeric component that represents the most significant digit of the number, and a combining process that, each time an array is received from the client, performs calculation processing using a new array generated by combining, element by element, the numbers of the received array with those of a stored array, wherein the client repeats processing in which, for a number remaining for each element after subtracting, from the numbers of the array before splitting, the numbers of the split array element by element, the client generates an array obtained by splitting off a numeric component that represents the most significant digit of the remaining number and transmits the array.

According to the present disclosure, the transmission time of data for causing another computer to execute processing can be shortened.

### BRIEF DESCRIPTION OF DRAWINGS

FIG. 1 is a block diagram illustrating a configuration example of the information processing system according to the present disclosure.

FIG. 2 is an explanatory diagram illustrating an example of a first splitting method.

FIG. 3 is an explanatory diagram illustrating processing in a first specific example.

FIG. 4 is an explanatory diagram illustrating an example of a second splitting method.

FIG. 5 is an explanatory diagram illustrating an example of a third splitting method.

FIG. 6 is an explanatory diagram illustrating an example of the operation of the information processing system according to the present disclosure.

FIG. 7 is a flowchart illustrating an example of processing according to the first splitting method.

FIG. 8 is a flowchart illustrating an example of processing according to the second splitting method.

FIG. 9 is a flowchart illustrating an example of processing according to the third splitting method.

FIG. 10 is a block diagram illustrating another configuration example of the information processing system according to the present disclosure.

FIG. 11 is an explanatory diagram illustrating another example of the first splitting method.

FIG. 12 is an explanatory diagram illustrating another example of the second splitting method.

FIG. 13 is an explanatory diagram illustrating another example of the third splitting method.

FIG. 14 is an explanatory diagram illustrating another example of the operation of the information processing system according to the present disclosure.

FIG. 15 is a flowchart illustrating another example of processing according to the first splitting method.

FIG. 16 is a flowchart illustrating another example of processing according to the second splitting method.

FIG. 17 is a flowchart illustrating another example of processing according to the third splitting method.

FIG. 18 is an explanatory diagram illustrating an example of annealing results.

FIG. 19 is a block diagram illustrating an overview of the information processing system according to the present disclosure.

FIG. 20 is a block diagram illustrating an overview of the array splitting device according to the present disclosure.

FIG. 21 is a block diagram illustrating an overview of the array combining device according to the present disclosure.

FIG. 22 is a schematic block diagram illustrating a configuration of a computer according to at least one example embodiment.

### DETAILED DESCRIPTION OF THE INVENTION

First, a situation in which the information processing system of the present disclosure operates will be described. In recent years, computers called Ising machines have been increasingly used to solve combinatorial optimization problems at high speed. In particular, Ising machines used to solve large-scale combinatorial optimization problems often reside in the cloud.

Accordingly, to utilize an Ising machine in the cloud, a problem model needs to be transmitted. On the other hand, transmitting a large-scale problem to the cloud side takes a long time. For example, when the number of variables included in a problem model is 300,000, the size of the problem data (double precision) reaches 400 GB, and even with a 100-Mbps communication line, data transmission takes 32,000 seconds (approximately 8 hours and 53 minutes). If it takes a long time to transmit the problem, it is difficult to fully leverage the advantage of the Ising machine, which is the ability to solve combinatorial optimization problems quickly.

Here, in order to prevent know-how of formulating a combinatorial optimization problem from leaking to a provider of the environment of the other computer to which the problem is to be solved, it is preferable to be able to transmit the problem model as is. Therefore, the present disclosure describes a method for shortening the transmission time of data for causing another computer to execute processing by splitting the problem with respect to the digits of numbers that represent the model. Example embodiments of the present disclosure will be described below with reference to the drawings.

### Example Embodiment 1

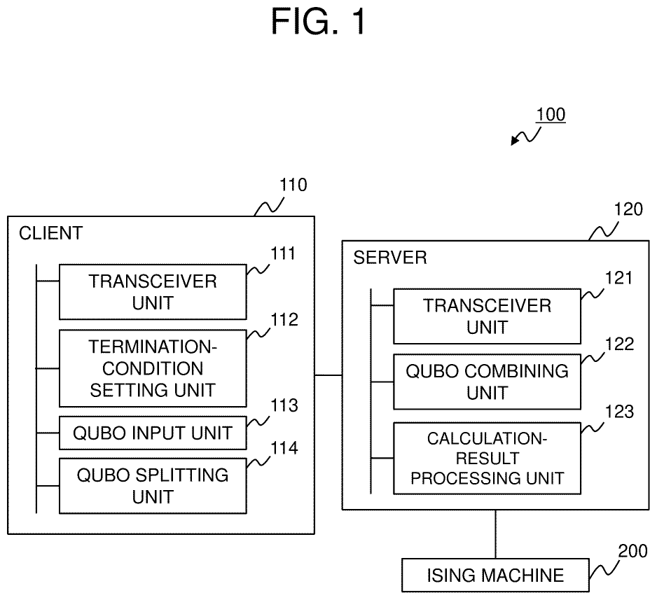

FIG. 1 is a block diagram illustrating a configuration example of a first example embodiment of the information processing system according to the present disclosure. The information processing system 100 of this example embodiment includes a client 110 and a server 120. The client 110 and the server 120 are mutually connected via a communication network.

The client 110 and the server 120 are implemented by any computer(s). In this example embodiment, a case is exemplified in which the server 120 is connected to an Ising machine 200. However, the server 120 itself may be implemented as the Ising machine.

The client 110 includes a transceiver unit 111, a termination-condition setting unit 112, a QUBO input unit 113, and a QUBO splitting unit 114.

The transceiver unit 111 performs transmission and reception of data with a server 120. The transceiver unit 111 may also transmit to the server 120 various conditions (for example, initial conditions) necessary for calculation processing (for example, processing for solving a combinatorial optimization problem) to be executed by the server 120.

The termination-condition setting unit 112 transmits to the server 120 a condition (an end condition) for terminating the calculation processing to be executed by the server 120. For example, when the server 120 executes calculation processing for solving a combinatorial optimization problem, the termination-condition setting unit 112 may transmit to the server 120 a condition for the maximum calculation time for the server 120 to execute the calculation processing or a convergence condition for determining that a calculation result has converged.

A QUBO input unit 113 receives input of a model indicating the content of the calculation to be executed by the server 120. Specifically, the QUBO input unit 113 receives input of an array whose elements are numbers representing the contents of the model. In the following description, the array representing the contents of the input model is sometimes referred to as an input array.

In this example embodiment, as an example of calculation processing to be executed by the server 120, calculation processing for solving a combinatorial optimization problem is assumed, and a QUBO (Quadratic Unconstrained Binary Optimization) matrix is exemplified as an array whose elements are numbers. However, the calculation handled by the server 120 is not limited to combinatorial optimization problems, and the array whose elements are numbers is not limited to a QUBO matrix. For example, the array whose elements are numbers may be represented by an Ising model equivalent to QUBO.

The method for representing numbers is arbitrary, and numbers may be represented by ordinary decimal real numbers or integers, or by floating-point numbers (double precision or single precision).

A QUBO splitting unit 114 generates, for each element of the input array, an array obtained by splitting off a numeric component that represents the most significant digit of the number. For example, assume that the number is “1234” expressed in decimal. In this case, the most significant digit in decimal is the thousands place, and since the digit in the thousands place is “1,” the numeric component representing the most significant digit of the number “1234” in decimal is “1.”

The manner in which numerical values of the elements of the array are handled may be predetermined between the client 110 and the server 120.

The QUBO splitting unit 114 transmits to the server 120 the array generated by splitting the original array (hereinafter also referred to as the first array). In the initial state, the QUBO splitting unit 114 transmits to the server 120 the array generated by splitting the input array.

Furthermore, the QUBO splitting unit 114 calculates an array (hereinafter also referred to as the second array) obtained by subtracting, element by element, the numbers of the split array from the numbers of the array before splitting. Then, for each element of the generated array, the QUBO splitting unit 114 generates an array obtained by splitting off a numeric component that represents the most significant digit of the remaining number and transmits the array to the server 120. The splitting here is the same as that described above.

Thereafter, the QUBO splitting unit 114 repeats the splitting and transmission processing to the server 120 until all numbers of the elements included in the array remaining after the splitting (that is, the second array) become zero. The timing at which the QUBO splitting unit 114 transmits the array generated (that is, the first array) is arbitrary. The QUBO splitting unit 114 may transmit the first array to the server 120 in response to an instruction from a calculation-result processing unit 123 of the server 120, which will be described later, or may transmit the first array to the server 120 immediately after the array is generated.

Specific examples of methods by which the QUBO splitting unit 114 splits the array will be described below. In the following examples, it is assumed that the problem model (that is, the array) is represented by a QUBO matrix, and the numbers represented by the elements of the QUBO matrix are handled as double-precision floating-point numbers.

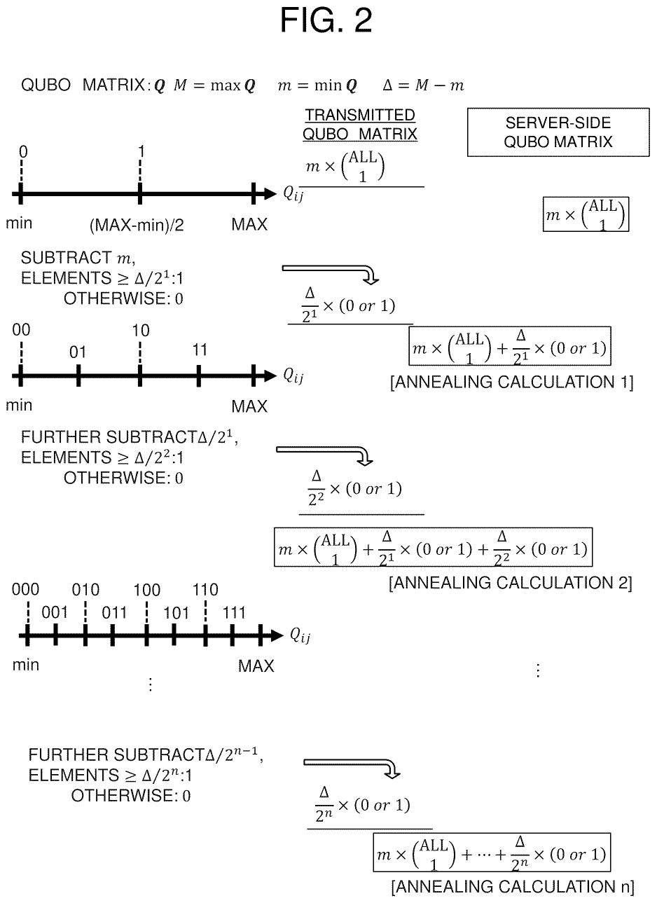

First, a first specific example will be described. FIG. 2 is an explanatory diagram illustrating an example of a first splitting method. First, the QUBO splitting unit 114 acquires a maximum value M (maxQ) and a minimum value m (minQ) among the elements of the QUBO matrix Q. Then, the QUBO splitting unit 114 calculates a difference Δ between the acquired maximum value M and the minimum value m.

Next, the QUBO splitting unit 114 splits from the original matrix Q a matrix represented by Expression (1) below and transmits it to the server 120. Since the first term in Expression (1) is a reference matrix obtained by multiplying the minimum value m, the first term is also referred to as a minimum-value matrix in the following description. The second term in Expression (1) is a difference matrix between the matrix Q and the minimum-value matrix, and is also referred to as a difference matrix in the following description. Each time a matrix is transmitted to the server 120, calculation processing using the transmitted array is performed on the server side.

$$\begin{matrix}[ Expression 1 ] & \\ m \times ( \begin{matrix}ALL \\ 1\end{matrix} ) + \frac{Δ}{{2}^{1}} \times ( 0 or 1 ) & ( Equation 1 )\end{matrix}$$

In Expression (1), each element of the matrix (that is, the difference matrix) whose elements are “0 or 1” is determined as follows. Specifically, the QUBO splitting unit 114 subtracts m from the array to be split, and if the subtracted value is greater than or equal to Δ/2¹, the element is set to 1; otherwise, the element is set to 0. This processing corresponds to extracting a bit that represents the most significant digit when a numerical value is represented by two bits. The same applies to the splitting methods described below.

Then, the QUBO splitting unit 114 transmits to the server 120 a matrix obtained by adding to the difference matrix another matrix obtained by multiplying the generated matrix by a coefficient calculated as Δ/2¹ (that is, 8). The QUBO splitting unit 114 may transmit the difference matrix in advance when the difference matrix is calculated. In that case, the QUBO splitting unit 114 only needs to transmit to the server 120 the matrix obtained by multiplying the generated matrix by the coefficient calculated as Δ/2¹ (that is, 8).

Next, the QUBO splitting unit 114 subtracts from the matrix Q the numerical values of the elements of the transmitted matrix, and if the subtracted value is greater than or equal to Δ/2², the element is set to 1; otherwise, the element is set to 0. Then, the QUBO splitting unit 114 transmits to the server 120 a matrix obtained by adding to the difference matrix another matrix obtained by multiplying the generated matrix by a coefficient calculated as Δ/2² (that is, 4).

Thereafter, the QUBO splitting unit 114 repeats the processing in which, from the matrix Q, numerical values of the elements of matrices transmitted to the server are subtracted, and if the subtracted value is greater than or equal to Δ/2ⁿ (where n is the number of splitting times), the element is set to 1; otherwise, the element is set to 0.

In the case of a QUBO matrix, since elements other than the upper triangular matrix components are zero, in the “all 1” matrix in Expression (1) above, only the upper triangular components may be set to 1.

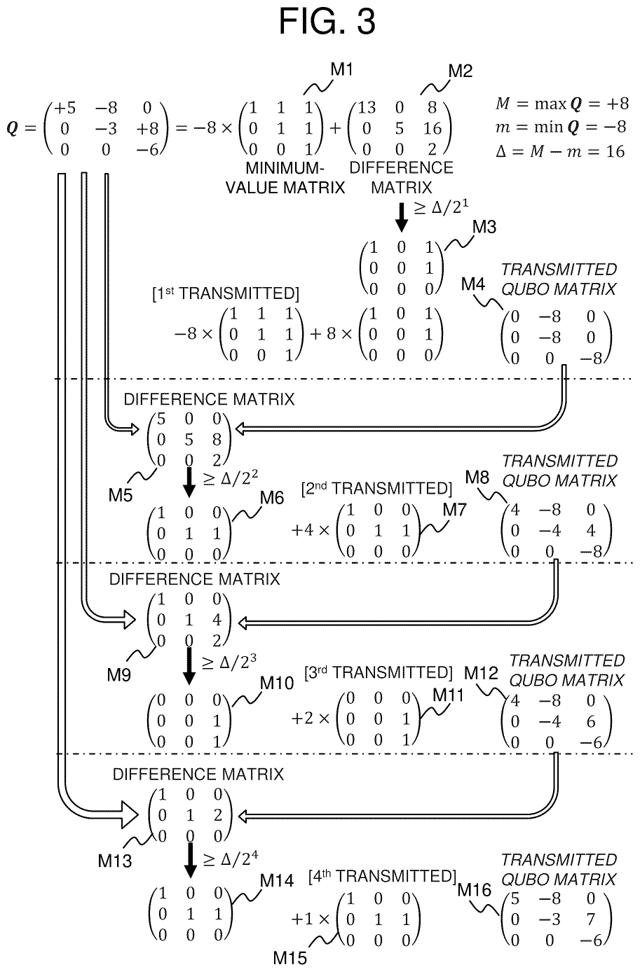

Next, the first specific example will be described in more detail by using specific numerical values. FIG. 3 is an explanatory diagram illustrating the processing of the first specific example. In the example shown in FIG. 3, it is assumed that a matrix Q is input in which the first-row elements are [+5, −8, 0], the second-row elements are [0, −3, +8], and the third-row elements are [0, 0, −6].

The QUBO splitting unit 114 acquires +8, which is the maximum value M (=maxQ), and −8, which is the minimum value m (=minQ), of the matrix Q. Furthermore, the QUBO splitting unit 114 calculates a difference Δ between the maximum value M and the minimum value m as M−m=16.

The QUBO splitting unit 114 generates, from the input matrix Q, a minimum-value matrix M1 obtained by multiplying the minimum value −8 and setting the upper triangular components of the matrix to 1, and a difference matrix M2. The QUBO splitting unit 114 identifies elements of the difference matrix M2 whose numerical values are greater than or equal to Δ/2¹, sets those elements to 1 and others to 0, and generates a matrix M3. The QUBO splitting unit 114 transmits to the server 120 a matrix M4 obtained by adding to the minimum-value matrix M1 another matrix obtained by multiplying the generated matrix M3 by a coefficient 8 (16/2¹).

Next, the QUBO splitting unit 114 subtracts the transmitted matrix M4 from the matrix Q to generate a new difference matrix M5. The QUBO splitting unit 114 identifies elements of the difference matrix whose numerical values are greater than or equal to Δ/2², sets those elements to 1 and others to 0, and generates a matrix M6. Then, the QUBO splitting unit 114 transmits to the server 120 a matrix M7 obtained by adding to the generated matrix M6 another matrix obtained by multiplying the generated matrix by a coefficient 4 (16/2²).

As a result of the matrices M4 and M7 being transmitted to the server 120, a combining process is performed by a QUBO combining unit 122, which will be described later, and a matrix M8 is generated.

Similarly, the QUBO splitting unit 114 subtracts from the matrix Q the matrices M4 and M7 (that is, the matrix M8) that have been transmitted, to generate a new difference matrix M9. The QUBO splitting unit 114 identifies elements of the difference matrix whose numerical values are greater than or equal to Δ/2³, sets those elements to 1 and others to 0, and generates a matrix M10. Then, the QUBO splitting unit 114 transmits to the server 120 a matrix M11 obtained by adding to the generated matrix M10 another matrix obtained by multiplying the generated matrix by a coefficient 2 (16/2³).

As a result of the matrices M4, M7, and M11 being transmitted to the server 120, a combining process is performed by the QUBO combining unit 122, which will be described later, and a matrix M12 is generated.

Furthermore, the QUBO splitting unit 114 subtracts from the matrix Q the matrices M4, M7, and M11 (that is, the matrix M12) that have been transmitted, to generate a new difference matrix M13. The QUBO splitting unit 114 identifies elements of the difference matrix whose numerical values are greater than or equal to Δ/2⁴, sets those elements to 1 and others to 0, and generates a matrix M14. Then, the QUBO splitting unit 114 transmits to the server 120 a matrix M15 obtained by adding to the generated matrix M14 another matrix obtained by multiplying the generated matrix by a coefficient 1 (16/2⁴).

As a result of the matrices M4, M7, M11, and M15 being transmitted to the server 120, a combining process is performed by the QUBO combining unit 122, which will be described later, and a matrix M16 is generated. Thereafter, the QUBO splitting unit 114 repeats the above processing until all the elements of the difference matrix become zero.

As described above, the QUBO splitting unit 114 may transmit to the server an array represented as a product of a value obtained by dividing a difference Δ between the maximum value and the minimum value of the elements of the array by 2ⁿ, which increases with each splitting count n, and a matrix represented by two values of 0 and 1.

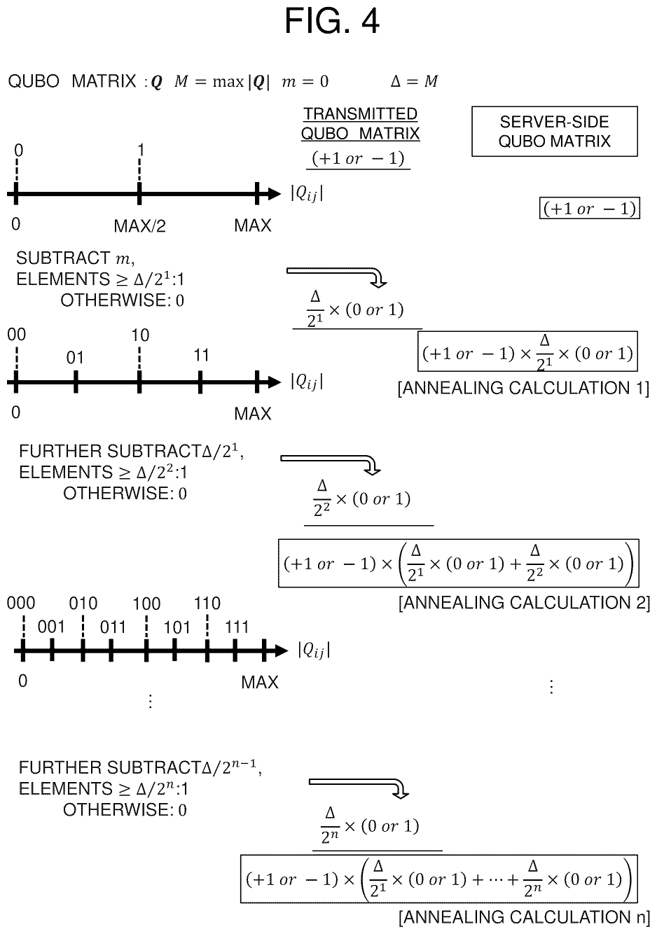

Next, a second specific example of a method for splitting an array by the QUBO splitting unit 114 will be described. FIG. 4 is an explanatory diagram illustrating an example of a second splitting method. In the case of a QUBO matrix, the numerical values are often distributed evenly over a range including both positive and negative values (for example, a uniform distribution). Therefore, in the second specific example, absolute values of the numbers are used. Specifically, the QUBO splitting unit 114 acquires a maximum value M (=max|Q|) and a minimum value m (=0) among the absolute values of the elements of the QUBO matrix Q. Then, the QUBO splitting unit 114 calculates a difference Δ (that is, M) between the acquired maximum value M and minimum value m.

Next, the QUBO splitting unit 114 splits from the original matrix Q a matrix represented by Expression (2) below and transmits it to the server 120. In Expression (2), the first matrix represents the sign of each numerical element, while the last matrix in Expression (2) is similar to the difference matrix shown in the first specific example. The difference from the first specific example is that the object of splitting is the absolute value of each element, and the product of the sign matrix transmitted first to the server 120 and the corresponding matrix is calculated.

$$( + 1 or - 1 ) \times \frac{Δ}{{2}^{1}} \times ( 0 or 1 ) \qquad ( Equation 2 )$$

In this way, the QUBO splitting unit 114 may transmit to the server an array represented as a product of a matrix indicating the sign of each element of the array (QUBO matrix), a value obtained by dividing the maximum absolute value of the elements by a power of two, 2ⁿ, that increases with each division of the array, and a matrix represented by two values of 0 and 1.

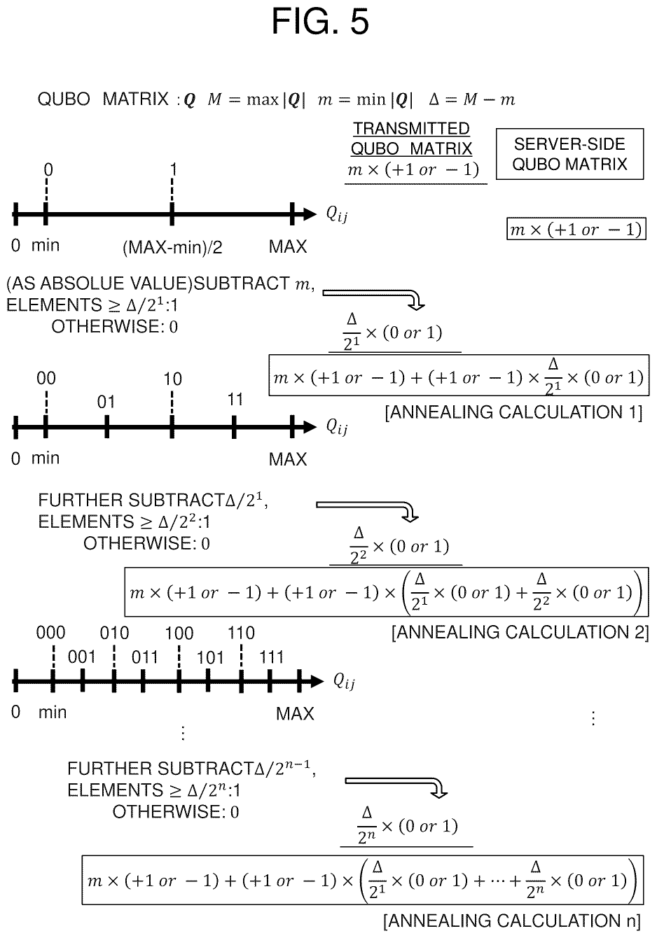

Next, a third specific example of a method for splitting an array by the QUBO splitting unit 114 will be described. FIG. 5 is an explanatory diagram illustrating an example of a third splitting method. In the second specific example above, when absolute values are used, there may be cases in which the minimum value is apart from zero (for example, larger than a predetermined reference value). Therefore, in the third specific example, the QUBO splitting unit 114 acquires a maximum absolute value M (=max|Q|) and a minimum absolute value m (=min|Q|) among the absolute values of the elements of the QUBO matrix Q. Then, the QUBO splitting unit 114 calculates a difference Δ (that is, M−m) between the acquired maximum absolute value M and minimum absolute value m.

Next, the QUBO splitting unit 114 splits from the original matrix Q a matrix represented by Expression (3) below and transmits it to the server 120. In Expression (3), the first term is a reference matrix obtained by multiplying the sign and the minimum value m, corresponding to the minimum-value matrix in the first specific example. The second term in Expression (3) corresponds to the matrix described in the second specific example. As for the sign, as in the second specific example, it is sufficient that the product of the sign matrix transmitted first to the server 120 and the corresponding matrix is calculated.

$$\begin{matrix}[ Expression 3 ] & \\ ( + 1 or - 1 ) \times m + ( + 1 or - 1 ) \times \frac{Δ}{{2}^{1}} \times ( 0 or 1 ) & ( Equation 3 )\end{matrix}$$

In this way, the QUBO splitting unit 114 may transmit to the server an array represented as a product of a matrix indicating the sign of each element of the array (QUBO matrix) and a value obtained by dividing a difference Δ between the maximum absolute value and minimum absolute value of the elements by 2ⁿ, which increases with each splitting count n, and a matrix represented by two values of 0 and 1.

The method by which the QUBO splitting unit 114 splits an array may be predetermined in advance, or the method for splitting the array may be determined according to the distribution of the numerical values of the elements of the input array (the input array).

In the first to third splitting methods described above, the QUBO splitting unit 114 transmits to the server an array (QUBO matrix) generated by splitting, bit by bit from the most significant digit, the numerical values of the difference matrix. The unit of splitting is not limited to one bit, and may be two or more bits.

The transceiver unit 111, the termination-condition setting unit 112, the QUBO input unit 113, and the QUBO splitting unit 114 are implemented by a processor (for example, a CPU (Central Processing Unit)) of a computer operating in accordance with a program (an array splitting program). For example, the program may be stored in a storage unit (not shown) of the client 110, and the processor may read the program and operate as the transceiver unit 111, the termination-condition setting unit 112, the QUBO input unit 113, and the QUBO splitting unit 114 in accordance with the program.

Each function of the client 110 may be provided in the form of Software as a Service (SaaS). Alternatively, the transceiver unit 111, the termination-condition setting unit 112, the QUBO input unit 113, and the QUBO splitting unit 114 may each be implemented by dedicated hardware.

Apart or all of the constituent elements of each device may be implemented by general-purpose or dedicated circuitry, processors, or a combination thereof. These may be constituted by a single chip or by a plurality of chips connected via a bus. A part or all of the constituent elements of each device may be implemented by a combination of the above-mentioned circuitry and programs.

When a part or all of the constituent elements of the client 110 are implemented by a plurality of information processing devices or circuits, the plurality of information processing devices or circuits may be arranged in a centralized manner or in a distributed manner. For example, the information processing devices or circuits may be realized in a configuration in which they are connected to each other via a communication network, such as in a client-server system or a cloud computing system.

On the other hand, the server 120 includes a transceiver unit 121, a QUBO combining unit 122, and a calculation-result processing unit 123. The server 120 is communicably connected to an Ising machine 200.

The transceiver unit 121 controls transmission and reception of data with the client 110. Specifically, the transceiver unit 121 receives arrays transmitted from the client 110 and stores the received arrays. The transceiver unit 121 may store the received arrays in a storage unit (not shown) included in the server 120.

The QUBO combining unit 122 generates a new array by combining, element by element, the numerical values of the received array with those of previously received arrays each time an array is received from the client 110. Specifically, the QUBO combining unit 122 adds the numerical values of the received array to those of the stored array element by element to generate a new array to be used for calculation processing described later.

Then, the QUBO combining unit 122 performs calculation processing using the generated new array. In this example embodiment, the QUBO combining unit 122 transmits a QUBO matrix to the Ising machine 200 and causes it to execute calculation processing (more specifically, combinatorial optimization processing). Since the method by which the Ising machine 200 performs calculation processing using a QUBO matrix is well known, detailed explanation thereof will be omitted here.

The calculation-result processing unit 123 determines whether to continue the calculation processing based on the calculation result. In this example embodiment, a termination condition for terminating the calculation processing executed by the server 120 is set by the termination-condition setting unit 112 of the client 110. Therefore, the calculation-result processing unit 123 determines, based on the calculation result, whether the termination condition has been satisfied. If the termination condition is satisfied, the calculation-result processing unit 123 transmits the calculation result to the client 110.

The transceiver unit 121, the QUBO combining unit 122, and the calculation-result processing unit 123 are implemented by a processor (for example, a CPU) of a computer operating in accordance with a program (an array combining program).

As described above, since the client 110 performs processing for splitting an input array, the client 110 can be referred to as an array splitting device, and since the server 120 performs processing for combining and processing received arrays, the server 120 can be referred to as an array combining device.

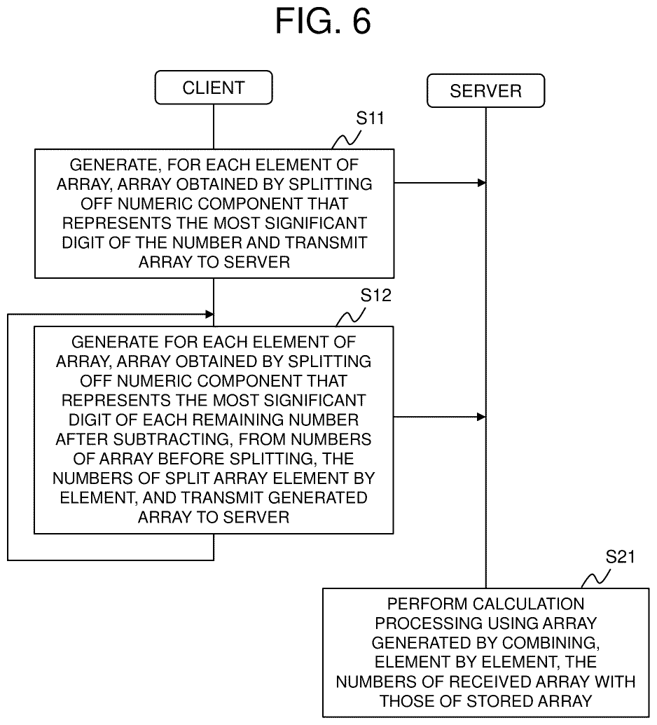

Next, the operation of the information processing system according to the first example embodiment will be described. FIG. 6 is an explanatory diagram illustrating an example of the operation of the information processing system according to this example embodiment. The QUBO splitting unit 114 of the client 110 generates, for each element of the array, an array obtained by splitting off a numeric component that represents the most significant digit of the number and transmits the array to the server 120 (step S11). Thereafter, the QUBO splitting unit 114 repeats processing in which, for each element of the array, after subtracting, from the numbers of the array before splitting, the numbers of the split array element by element, the unit generates an array obtained by splitting off a numeric component that represents the most significant digit of each remaining number and transmits the array to the server 120 (step S12). Meanwhile, QUBO combining unit 122 of the server 120 performs, each time an array is received from the client, calculation processing using a new array generated by combining, element by element, the numbers of the received array with those of a stored array. (step S21).

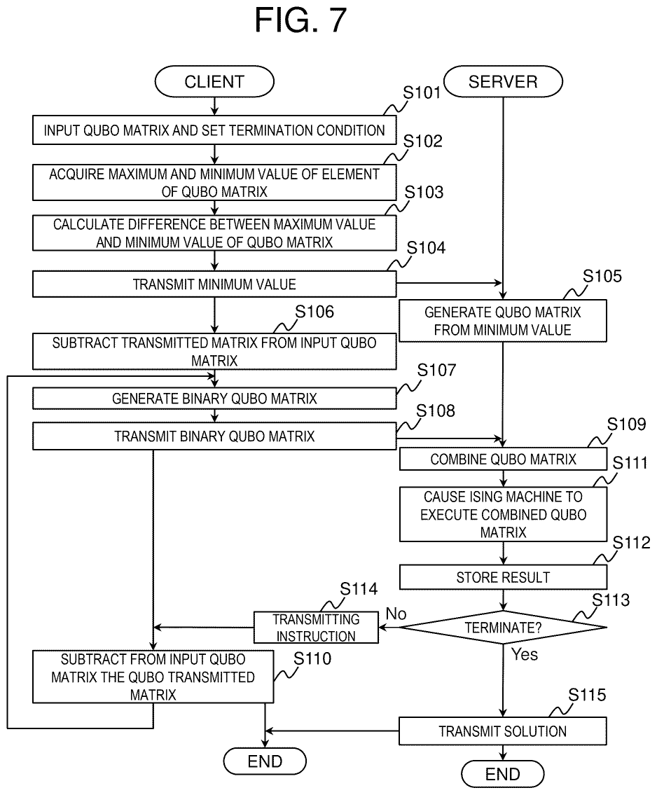

Next, processing according to the method by which the QUBO splitting unit 114 splits an array (specifically, a QUBO matrix) will be described. First, specific processing according to the first splitting method will be described. FIG. 7 is a flowchart illustrating an example of processing according to the first splitting method.

The QUBO input unit 113 receives input of a QUBO matrix, and the termination-condition setting unit 112 sets a termination condition for calculation processing by the Ising machine 200 at the server 120 (step S101).

The QUBO splitting unit 114 acquires a maximum value and a minimum value of the elements of the input QUBO matrix (step S102). Furthermore, the QUBO splitting unit 114 calculates a difference between the maximum value and the minimum value of the QUBO matrix (step S103). After acquiring the minimum value, the transceiver unit 111 transmits the minimum value of the QUBO matrix to the transceiver unit 121 of the server 120 (step S104).

The QUBO combining unit 122 generates and stores, as an initial problem to be solved by the Ising machine 200, a QUBO matrix based on the minimum value received by the transceiver unit 121 (step S105). The QUBO matrix generated here corresponds to the minimum-value matrix described above.

Meanwhile, the QUBO splitting unit 114 subtracts the transmitted matrix from the input QUBO matrix to generate a difference matrix (step S106). The QUBO splitting unit 114 then generates a binary QUBO matrix having only “0 or 1” elements from the difference matrix and generates a QUBO matrix obtained by multiplying it by a real-number coefficient (step S107). Specifically, the QUBO splitting unit 114 generates a matrix obtained by multiplying the binary QUBO matrix, whose elements are only “0 or 1,” by a value of Δ/2ⁿ (that is, the difference Δ divided by 2 to the power of the splitting count n) as the real-number coefficient. Then, the QUBO splitting unit 114 transmits to the transceiver unit 121 of the server 120 the binary QUBO matrix generated in step S107 (step S108).

The QUBO combining unit 122 of the server 120 combines (adds) the received QUBO matrix with the QUBO matrix that has been stored up to that point (step S109). On the other hand, the QUBO splitting unit 114 of the client 110 subtracts from the input QUBO matrix the QUBO matrix generated by the server 120 (that is, the QUBO matrix transmitted to the server 120) to generate a difference matrix (step S110).

The QUBO combining unit 122 of the server 120 causes the Ising machine 200 to execute a solving process for the QUBO matrix generated in step S109 (step S111). Then, the calculation-result processing unit 123 receives and stores a result obtained by the Ising machine 200 solving the QUBO matrix (step S112).

The calculation-result processing unit 123 determines, based on the set termination condition, whether to terminate the process (step S113). Specifically, the calculation-result processing unit 123 determines whether to terminate the process of transmitting QUBO matrices from the client 110 to the server 120. If it is determined not to terminate the process (No in step S113), the calculation-result processing unit 123 issues to the client 110 an instruction to transmit a QUBO matrix (step S114).

On the other hand, if it is determined to terminate the process (Yes in step S113), the calculation-result processing unit 123 transmits a solution to the client 110 (step S115).

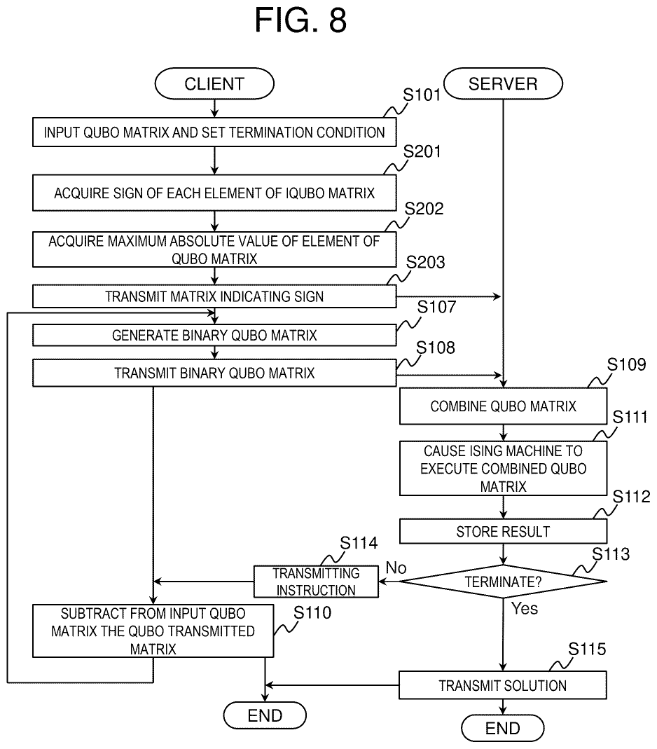

Next, specific processing according to the second splitting method will be described. FIG. 8 is a flowchart illustrating an example of processing according to the second splitting method. The processing for receiving input of a QUBO matrix and setting a termination condition is the same as that of step S101 illustrated in FIG. 7.

Next, the QUBO splitting unit 114 acquires the sign of each element of the input QUBO matrix (step S201). Furthermore, the QUBO splitting unit 114 acquires a maximum absolute value of the elements of the QUBO matrix (step S202). In this splitting method, the difference between the maximum and minimum values is the same as the maximum absolute value. Then, the transceiver unit 111 transmits to the transceiver unit 121 of the server 120 a matrix indicating the acquired signs (step S203).

Subsequent processing in which the QUBO splitting unit 114 repeatedly transmits the matrices generated to the server 120, and the QUBO combining unit 122 sequentially causes the Ising machine 200 to execute processing based on the received arrays, is the same as the processing from step S107 to step S115 illustrated in FIG. 7.

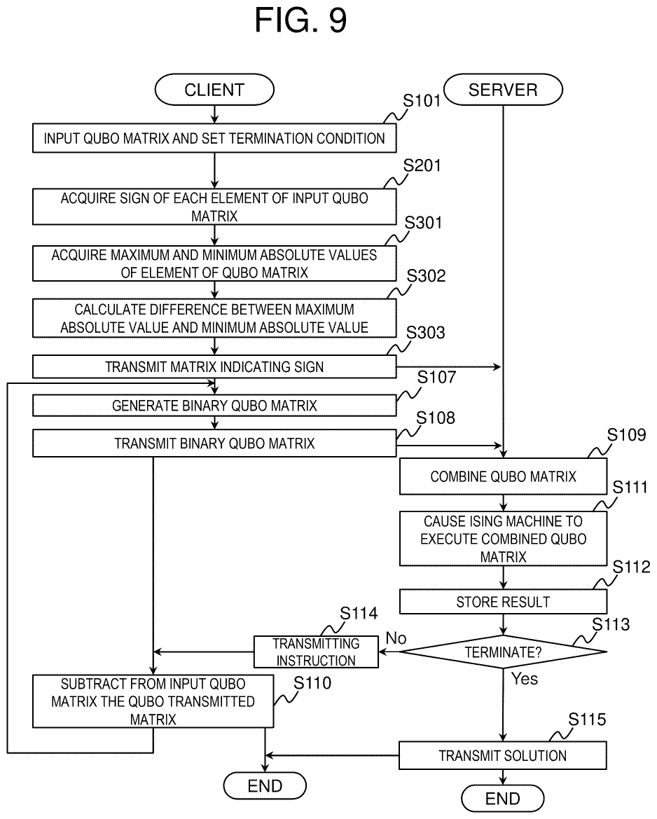

Next, specific processing according to the third splitting method will be described. FIG. 9 is a flowchart illustrating an example of processing according to the third splitting method. The processing for receiving input of a QUBO matrix, setting a termination condition, and acquiring the sign of each element of the QUBO matrix is the same as that of step S101 and step S201 illustrated in FIG. 8.

Next, the QUBO splitting unit 114 acquires a maximum absolute value and a minimum absolute value of the elements of the input QUBO matrix (step S301). The QUBO splitting unit 114 calculates a difference between the acquired maximum absolute value and minimum absolute value (step S302). Then, the transceiver unit 111 transmits to the transceiver unit 121 of the server 120 a matrix indicating the acquired signs (step S303).

Subsequent processing in which the QUBO splitting unit 114 repeatedly transmits the matrices generated to the server 120, and the QUBO combining unit 122 sequentially causes the Ising machine 200 to execute processing based on the received arrays, is the same as the processing from step S107 to step S115 illustrated in FIG. 8.

As described above, in this example embodiment, the QUBO splitting unit 114 generates, for each element of an input array whose elements are numbers, an array obtained by splitting off a numeric component that represents the most significant digit of the number and transmits the array to the server 120. Furthermore, the QUBO splitting unit 114 repeats processing in which, for each element of the array, after subtracting, from the numbers of the array before splitting, the numbers of the split array element by element, the unit generates an array obtained by splitting off a numeric component that represents the most significant digit of each remaining number and transmits the array to the server 120. The QUBO combining unit 122 performs calculation processing using a newly generated array obtained by combining, element by element, the numbers of the received array with those of a stored array each time an array is received from the client 110. Therefore, the transmission time of data for causing another computer to execute processing can be shortened.

For example, a traveling salesman problem, which is one type of combinatorial optimization problem, is a problem of finding a route for visiting a plurality of cities so that the travel distance becomes short. The optimal solution of the traveling salesman problem is a solution in which the visiting route is shortest; however, in cases where the objective can be achieved by obtaining a solution that allows the tour to be completed within a predetermined limited time, it may be acceptable to terminate the calculation before the shortest solution is obtained.

In a general method, large input data are transmitted to an Ising machine as they are, without omission, and calculation processing is often continued until the value of the objective function converges. In contrast, in the information processing system 100 of this example embodiment, the QUBO splitting unit 114 transmits to the server 120 input data that are reduced in calculation load due to omission, and the QUBO combining unit 122 causes the Ising machine 200 to perform calculation using those data. Then, the calculation-result processing unit 123 determines, based on whether the termination condition set by the termination-condition setting unit 112 has been satisfied, whether to continue the calculation processing. Therefore, the likelihood of finding a desired solution in a shorter time than with general methods can be increased.

In particular, when a combinatorial optimization problem is solved by annealing, it is well suited to the method of the present disclosure, in which calculation is first performed using rough data and then gradually performed using data of increasing precision.

### Example Embodiment 2

Next, a second example embodiment of the information processing system according to the present disclosure will be described. Depending on the model, a characteristic QUBO matrix may be used. For example, when the QUBO matrix is a sparse matrix that includes many zeros, a sparse matrix storage format (such as CSR (Compressed Sparse Row), CSC (Compressed Sparse Column), or COO (Coordinate)) can be used. These storage formats are methods that record only nonzero components. Among them, CSR and CSC allow faster matrix operations when the same format is used, while COO allows faster data manipulation.

When the QUBO matrix includes the same type of constraint condition, a small number of specific values may appear repeatedly. For example, the “one-hot” condition is a constraint in which only one of a plurality of variables having values of 0 or 1 takes the value 1, and is expressed as Σⁿᵢ₌₁ xᵢ=1. For example, when N=4, the QUBO matrix is represented by the matrix illustrated in the following example.

$$( \begin{matrix}- 1 & 2 & 2 & 2 \\ 0 & - 1 & 2 & 2 \\ 0 & 0 & - 1 & 2 \\ 0 & 0 & 0 & - 1\end{matrix} ) \qquad [ Expression 4 ]$$

The QUBO matrix shown above includes, as elements, N(N−1)/2 zeros, N elements of −1, and N(N−1)/2 elements of 2.

For example, a “two-way one-hot” condition is a constraint on two-dimensional variables (0 or 1) arranged in n rows and n columns, where one-hot conditions are imposed in both the row and column directions. This condition is expressed as Σⁿᵢ₌₁ xᵢⱼ=1 for all j, and Σⁿⱼ₌₁ xᵢⱼ=1 for all i (where N=n²). For example, when N=n²=9, the QUBO matrix is represented by the matrix illustrated in the following example.

$$( \begin{matrix}- 2 & 2 & 2 & 2 & 0 & 0 & 2 & 0 & 0 \\ 0 & - 2 & 2 & 0 & 2 & 0 & 0 & 2 & 0 \\ 0 & 0 & - 2 & 0 & 0 & 2 & 0 & 0 & 2 \\ 0 & 0 & 0 & - 2 & 2 & 2 & 2 & 0 & 0 \\ 0 & 0 & 0 & 0 & - 2 & 2 & 0 & 2 & 0 \\ 0 & 0 & 0 & 0 & 0 & - 2 & 0 & 0 & 2 \\ 0 & 0 & 0 & 0 & 0 & 0 & - 2 & 2 & 2 \\ 0 & 0 & 0 & 0 & 0 & 0 & 0 & - 2 & 2 \\ 0 & 0 & 0 & 0 & 0 & 0 & 0 & 0 & - 2\end{matrix} ) \qquad [ Expression 5 ]$$

The QUBO matrix shown above includes, as elements, n⁴−n³ zeros, n² elements of −2, and n²(n−1) elements of 2.

For such matrices, it is possible to perform data transmission using a more efficient storage format. Therefore, in this example embodiment, a method for further shortening the data transmission time is described, in which information that frequently appears within the array is extracted in advance and transmitted to the server.

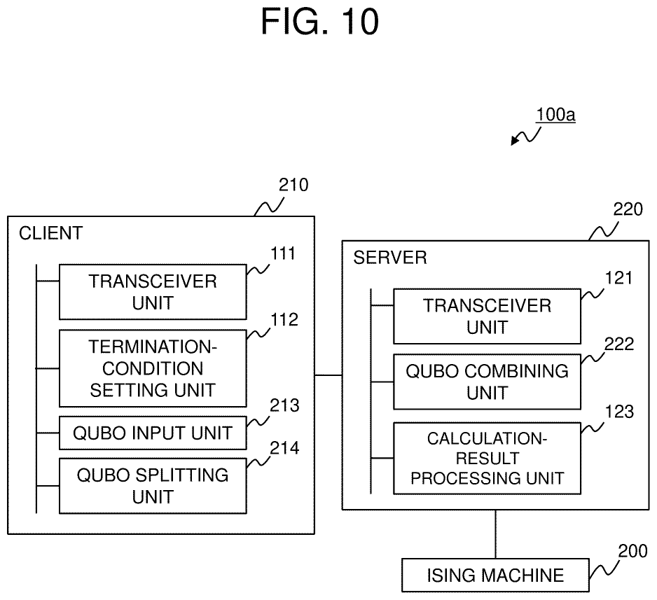

FIG. 10 is a block diagram illustrating a configuration example of the information processing system according to the second example embodiment of the present disclosure. The information processing system 100a of this example embodiment includes a client 210 and a server 220. The client 210 and the server 220 are mutually connected via a communication network. The client 210 and the server 220 are also each implemented by any computer (computing device).

The client 210 includes a transceiver unit 111, a termination-condition setting unit 112, a QUBO input unit 213, and a QUBO splitting unit 214. That is, the client 210 of this example embodiment differs from the client 110 of the first example embodiment in that it includes the QUBO input unit 213 and the QUBO splitting unit 214 instead of the QUBO input unit 113 and the QUBO splitting unit 114. The other configurations are the same as those of the first example embodiment.

A QUBO input unit 213 stores the QUBO matrix received as input in a sparse-matrix format. However, it is not essential that the QUBO matrix be stored in a sparse-matrix format.

A QUBO splitting unit 214 acquires the number of occurrences of each numerical value contained in the elements of the input array. Then, the QUBO splitting unit 214 converts the elements of the array into a sparse array or a sparse matrix format. Since methods for converting the elements of an array into a sparse array or sparse matrix format are well known, detailed description thereof will be omitted here.

The QUBO splitting unit 214 may convert the elements of the array into a sparse array or a sparse matrix format when there is a numerical value whose number of occurrences exceeds a predetermined criterion with respect to the total number of elements. The criterion defined here may, for example, be a ratio of the number of occurrences of a numerical value to the total number of elements.

The QUBO splitting unit 214 extracts, from the input array, elements having numerical values whose number of occurrences exceeds a predetermined criterion. Then, the QUBO splitting unit 214 generates an array composed of the extracted elements and transmits the array to the server 220. The QUBO splitting unit 214 generates an array (that is, a second array) obtained by subtracting, element by element, the numbers of the extracted array from the numbers of the input array. Thereafter, the processing in which the QUBO splitting unit 214 generates, for each remaining element, an array obtained by splitting off a numeric component that represents the most significant digit of each remaining number and transmits the array to the server 120 is the same as the processing performed by the QUBO splitting unit 114 in the first example embodiment.

Specific examples of methods by which the QUBO splitting unit 214 splits an array will be described below. In the following description, it is assumed that the input array, which is a QUBO matrix, is denoted as Q, and that numerical values a and b are frequently included among the elements of Q. A matrix A that includes all of a and b and whose other elements are zero is defined. Since A is transmitted to the server in advance, the QUBO matrix Q′ that is the target of digit-based splitting is expressed as Q′=Q−A.

Next, methods will be described in which, in addition to the first, second, and third splitting methods described in the first example embodiment, the processing of splitting arrays composed of elements whose numerical values have a number of occurrences exceeding a predetermined criterion is added.

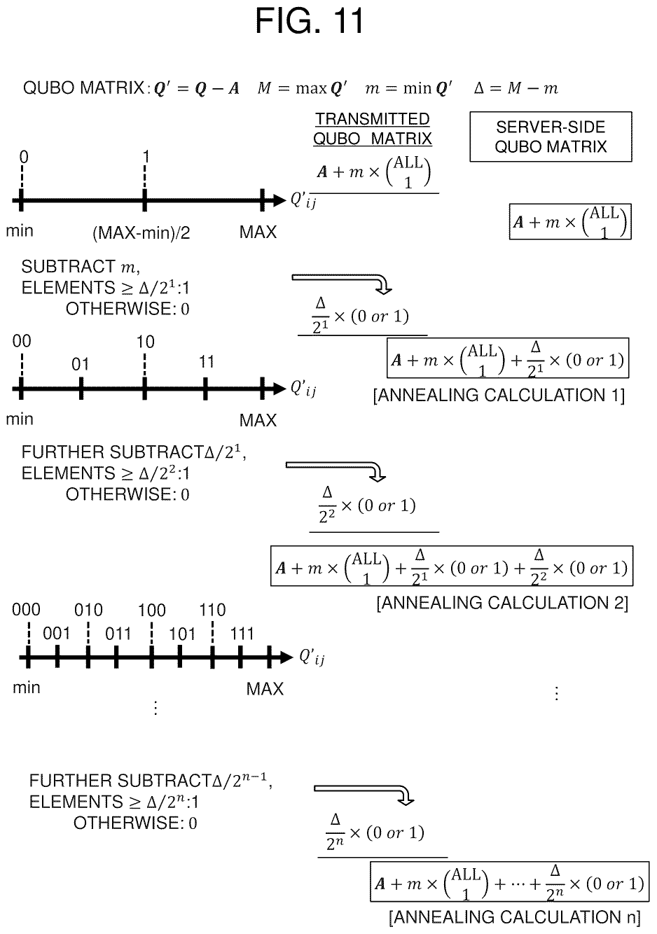

First, a first specific example will be described. FIG. 11 is an explanatory diagram illustrating another example of the first splitting method. In the example shown in FIG. 11, the maximum and minimum values are acquired from the elements of the QUBO matrix Q′. The QUBO splitting unit 214 transmits to the server 220 both the matrix A and a matrix obtained by splitting the minimum value. Subsequent processing is the same as in the first example embodiment.

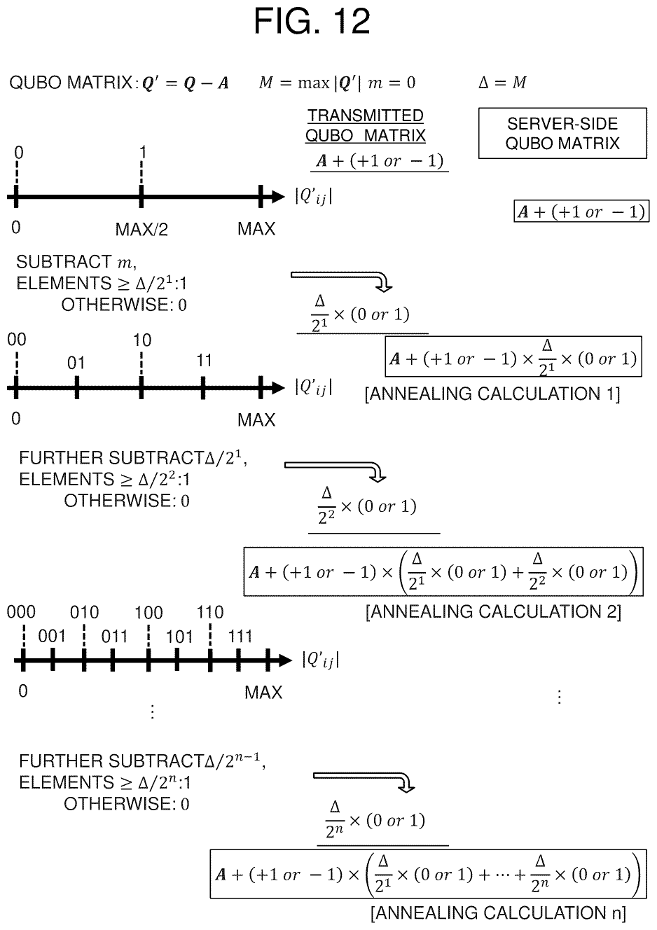

Next, a second specific example will be described. FIG. 12 is an explanatory diagram illustrating another example of the second splitting method. In the example shown in FIG. 12, the maximum absolute value is acquired from the absolute values of the elements of the QUBO matrix Q′. The QUBO splitting unit 214 transmits to the server 220 both the matrix A and a matrix obtained by splitting the sign. Subsequent processing is the same as in the first example embodiment.

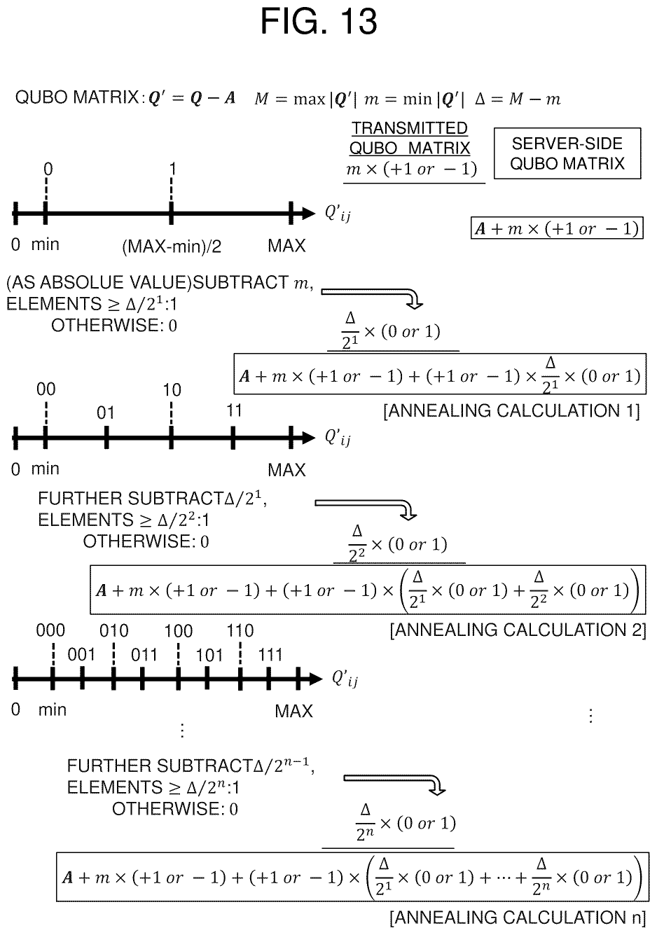

Next, a third specific example will be described. FIG. 13 is an explanatory diagram illustrating another example of the third splitting method. In the example shown in FIG. 13, the maximum absolute value and the minimum absolute value are acquired from the absolute values of the elements of the QUBO matrix Q′. The QUBO splitting unit 214 transmits to the server 220 both the matrix A and a matrix obtained by splitting the signed minimum value. Subsequent processing is the same as in the first example embodiment.

The transceiver unit 111, the termination-condition setting unit 112, the QUBO input unit 213, and the QUBO splitting unit 214 are implemented by a processor of a computer operating in accordance with a program (an array splitting program).

A server 220 includes a transceiver unit 121, a QUBO combining unit 222, and a calculation-result processing unit 123. That is, the server 220 of this example embodiment differs from the server 120 of the first example embodiment in that it includes the QUBO combining unit 222 instead of the QUBO combining unit 122. The other configurations are the same as those of the first example embodiment.

The QUBO combining unit 222 stores arrays received from the client 210. Specifically, the QUBO combining unit 222 receives and stores from the client an array composed of elements whose numerical values have a number of occurrences exceeding a predetermined criterion, extracted from the input array.

Then, as in the first example embodiment, the QUBO combining unit 222 of the server 220 performs calculation processing using a new array generated by combining (adding) the numerical values of the received array with those of a stored array element by element, each time an array is received from the client 210.

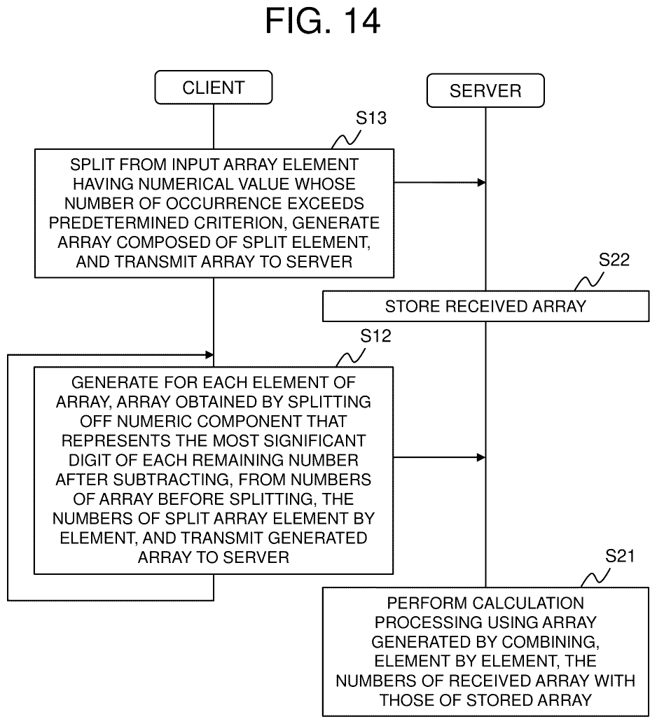

Next, the operation of the information processing system according to the second example embodiment will be described. FIG. 14 is an explanatory diagram illustrating an example of the operation of the information processing system 100a according to the second example embodiment.

The QUBO splitting unit 214 splits from the input array elements having numerical values whose number of occurrences exceeds a predetermined criterion, generates an array composed of the split elements, and transmits the array to the server 220 (step S13). Meanwhile, the QUBO combining unit 222 of the server 220 stores the received array (step S22).

Subsequent processing in which the QUBO splitting unit 214 transmits arrays generated to the server 220, and the QUBO combining unit 222 performs calculation processing each time an array is received, is the same as the processing of steps S12 and S21 illustrated in FIG. 6.

Next, processing according to the method by which the QUBO splitting unit 214 splits an array (specifically, a QUBO matrix) will be described. Differences between this example embodiment and the first example embodiment will be described, focusing on the first, second, and third splitting methods shown in the first example embodiment.

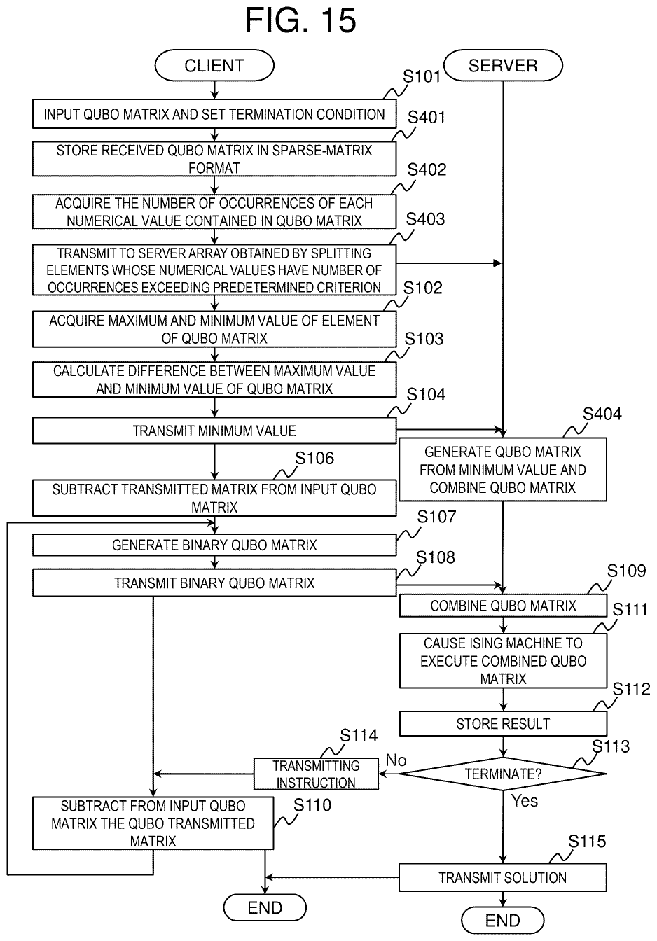

First, specific processing according to the first splitting method will be described. FIG. 15 is a flowchart illustrating another example of processing according to the first splitting method. The processing for receiving input of a QUBO matrix and setting a termination condition is the same as the content of step S101 illustrated in FIG. 6.

In addition, the QUBO input unit 213 stores the received QUBO matrix in a sparse-matrix format (step S401). The QUBO splitting unit 214 acquires the number of occurrences of each numerical value contained in the QUBO matrix (step S402). Then, the QUBO splitting unit 214 transmits to the server 220 an array obtained by splitting elements whose numerical values have a number of occurrences exceeding a predetermined criterion (step S403).

Thereafter, the processing of steps S102 to S104 illustrated in FIG. 7 is performed. The QUBO combining unit 222 of the server 220 generates a QUBO matrix from the received minimum value and combines it with the QUBO matrix composed of elements whose numerical values have a number of occurrences exceeding the predetermined criterion (step S404). The processing from step S106 onward is the same as that from step S106 onward illustrated in FIG. 7.

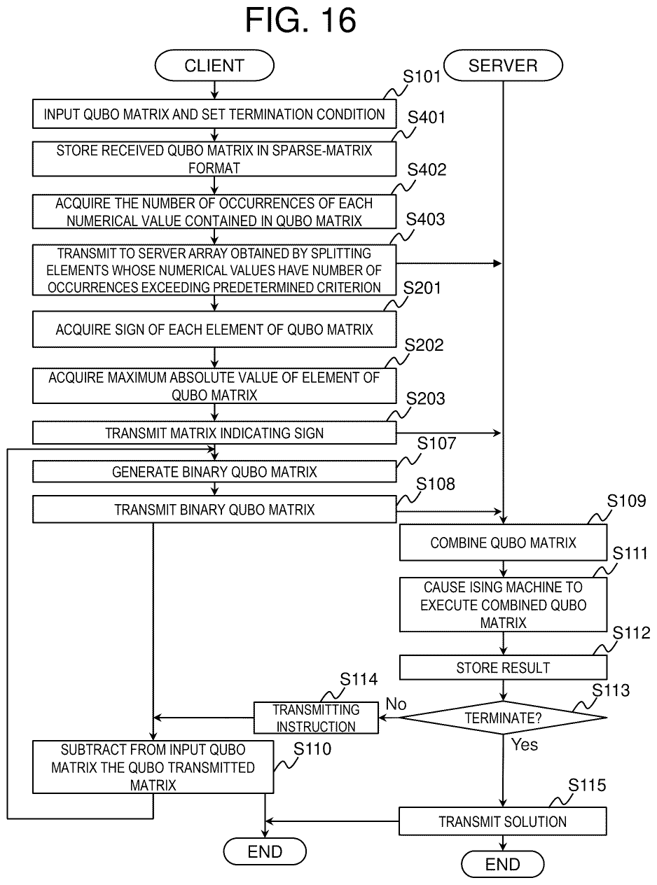

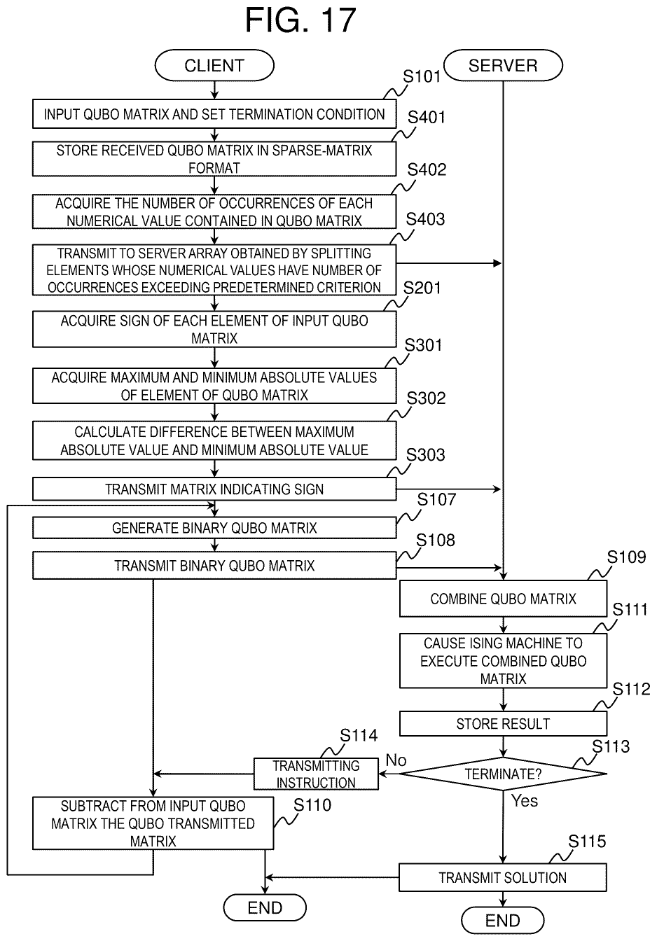

Next, specific processing according to the second splitting method will be described. FIG. 16 is a flowchart illustrating another example of processing according to the second splitting method. The processing for receiving input of a QUBO matrix and transmitting to the server 220 an array obtained by splitting elements whose numerical values have a number of occurrences exceeding a predetermined criterion is the same as the content of step S101 and steps S401 to S403 illustrated in FIG. 17. The processing from step S201 onward is the same as that from step S201 onward illustrated in FIG. 8.

Next, specific processing according to the third splitting method will be described. FIG. 17 is a flowchart illustrating another example of processing according to the third splitting method. As in the second splitting method, the processing for receiving input of a QUBO matrix and transmitting to the server 220 an array obtained by splitting elements whose numerical values have a number of occurrences exceeding a predetermined criterion is the same as the content of step S101 and steps S401 to S403 illustrated in FIG. 17. The processing from step S201 onward is the same as that from step S201 onward illustrated in FIG. 9.

As described above, in this example embodiment, the QUBO splitting unit 214 splits from the input array elements whose numerical values have a number of occurrences exceeding a predetermined criterion, generates an array composed of the split elements, and transmits the array to the server 220, and the QUBO combining unit 222 stores the received array. Therefore, in addition to the effects of the first example embodiment, it is possible to further shorten the data transmission time.

### Example

The present invention will now be described by way of a specific example; however, the scope of the present invention is not limited to the following contents. In this specific example, a QUBO having 2000 bits (10 MB in double precision) was used, and annealing calculation was performed by an Ising machine while increasing the coefficient by one bit at a time. The coefficients were generated from a uniform distribution as double-precision floating-point numbers ranging from −10 to +10.

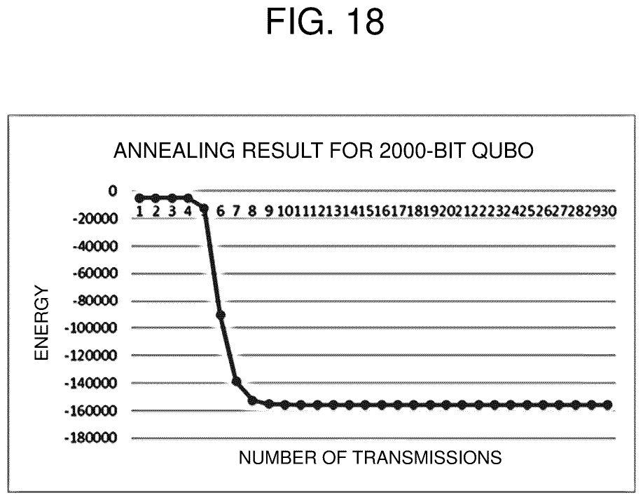

FIG. 18 is an explanatory diagram illustrating an example of annealing results. In this specific example, when the number of components was 16 types (4 bits), all of the solutions became 1. On the other hand, when the number of components reached around 256 types (8 bits), results close to the optimal solution were obtained. Furthermore, when the coefficients were transmitted sequentially from 1 bit to 30 bits and annealing calculations were performed, in 6 out of the 30 transmissions (at the 17-bit, 20-bit, 21-bit, 22-bit, 28-bit, and 29-bit transmissions), more favorable solutions were obtained than those obtained when the QUBO was transmitted as a whole without splitting.

From these results, it can be said that one advantage of the present disclosure is that performing annealing calculations repeatedly enables an increase in the number of samples that can be obtained.

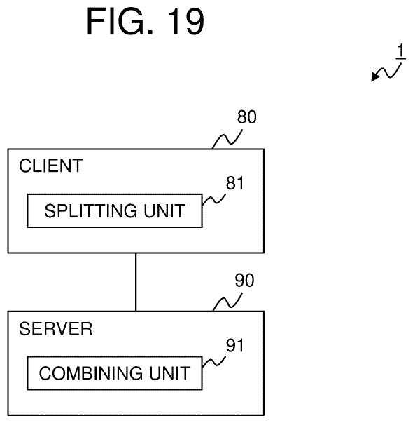

Next, an overview of the present disclosure will be described. FIG. 19 is a block diagram illustrating an overview of the information processing system according to the present disclosure. An information processing system 1 according to the present disclosure (for example, the information processing systems 100 and 100a) includes a client 80 (for example, the clients 110 and 210) that issues an execution instruction to another computer (for example, the servers 120 and 220) and a server 90 (for example, the servers 120 and 220) that receives the execution instruction from the client 80.

The client 80 includes a splitting unit 81 (for example, the QUBO splitting unit 114) that, for each element of an input array (for example, a QUBO matrix) whose elements are numbers, generates an array obtained by splitting off a numeric component that represents the most significant digit of the number and transmits the array to the server 90, and then repeats processing in which, for numbers remaining for each element after subtracting, from the numbers of the array before splitting, the numbers of the split array element by element, the splitting unit generates an array obtained by splitting off a numeric component that represents the most significant digit of each remaining number and transmits the array to the server 90.

The server 90 includes a combining unit 91 (for example, the QUBO combining unit 122) that, each time an array is received from the client 80, performs calculation processing using a new array generated by combining, element by element, the numbers of the received array with those of a stored array.

With such a configuration, the transmission time of data for causing another computer to execute processing can be shortened.

The splitting unit 81 of the client 80 may split off an element of a number whose number of appearances exceeds a predetermined criterion from the input array, generate an array composed of the split element, and transmit the array to the server 90, and the combining unit 91 of the server 90 may store the received array.

The combining unit 91 of the server 90 may cause an Ising machine (for example, the Ising machine 200) on the cloud to execute calculation processing.

The splitting unit 81 of the client 80 may transmit, to the server 90, an array generated by splitting the number of each element of the array one bit at a time from the most significant digit.

The splitting unit 81 of the client 80 may transmit to the server 90 an array represented as a product of a value obtained by dividing a difference between a maximum value and a minimum value of numbers of elements of the array by a power of two that increases with each division of the array, and a matrix represented by two values of 0 and 1.

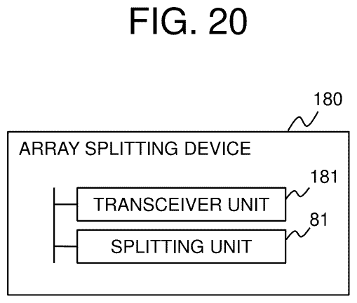

FIG. 20 is a block diagram illustrating an overview of an array splitting device according to the present disclosure. An array splitting device 180 (for example, the clients 110 and 210) according to the present disclosure includes a transceiver unit 181 and a splitting unit 81.

The transceiver unit 181 performs transmission and reception with a server (for example, the servers 120 and 220) that, each time an array whose elements are numbers is received, performs calculation processing using a new array generated by combining, element by element, the numbers of the received array with those of a stored array. The details of the splitting unit 81 are the same as those of the splitting unit 81 illustrated in FIG. 19.

With such a configuration as well, the transmission time of data for causing another computer to execute processing can be shortened.

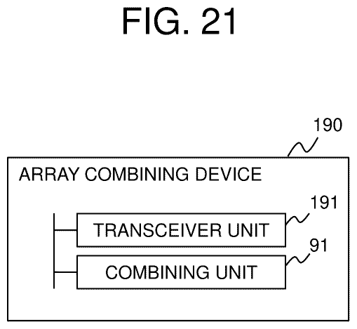

FIG. 21 is a block diagram illustrating an overview of an array combining device according to the present disclosure. An array combining device 190 (for example, the servers 120 and 220) according to the present disclosure includes a transceiver unit 191 and a combining unit 91.

The transceiver unit 191 performs transmission and reception with a client (for example, the clients 110 and 210) that, for each element of an input array whose elements are numbers, generates and transmits an array obtained by splitting off a numeric component that represents the most significant digit of the number. The details of the combining unit 91 are the same as those of the combining unit 91 illustrated in FIG. 19.

With such a configuration as well, the transmission time of data for causing another computer to execute processing can be shortened.

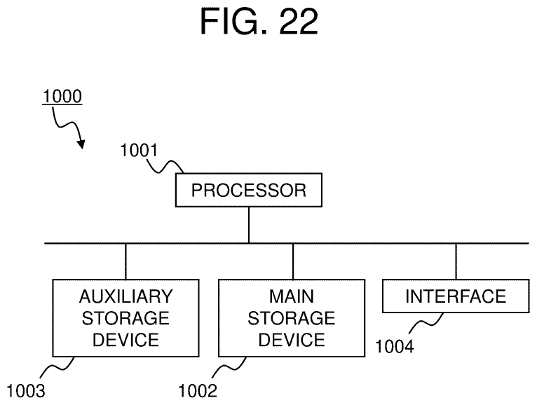

FIG. 22 is a schematic block diagram illustrating a configuration of a computer according to at least one example embodiment. A computer 1000 includes a processor 1001, a main storage 1002, an auxiliary storage 1003, and an interface 1004. Although only one computer 1000 is shown in FIG. 22, the number of computers 1000 is not limited to one and may be two or more. In addition, an Ising machine, an annealing machine, or a simulator may be connected to the computer 1000.

The information processing system 1 (more specifically, the client 80, the server 90, and so forth) described above is implemented on the computer 1000. The operations of the processing units described above are stored, in the form of programs (for example, an array splitting program or an array combining program), in the auxiliary storage 1003. The processor 1001 reads the program from the auxiliary storage 1003, expands it into the main storage 1002, and executes the above processing in accordance with the program.

In at least one example embodiment, the auxiliary storage 1003 is an example of a non-transitory tangible medium. Other examples of non-transitory tangible media include magnetic disks, magneto-optical disks, CD-ROMs (Compact Disc Read-Only Memory), DVD-ROMs (Digital Versatile Disc Read-Only Memory), and semiconductor memories connected via the interface 1004. When the programs are distributed to the computer 1000 via a communication line, the computer 1000 that receives the distribution may expand the programs into the main storage 1002 and execute the above processing.

The programs may be configured to realize only part of the above-described functions. Furthermore, the programs may be difference files (difference programs) configured to realize the above-described functions in combination with other programs already stored in the auxiliary storage 1003.

Apart or all of the above example embodiments may also be described as the following Supplementary notes, but are not limited thereto.

(Supplementary Note 1) An information processing system comprising:
a client that issues an execution instruction to another computer; and
a server that receives the execution instruction from the client,
wherein the client includes a splitting unit that, for each element of an input array whose elements are numbers, generates an array obtained by splitting off a numeric component that represents the most significant digit of the number and transmits the array to the server, and then repeats processing in which, for a number remaining for each element after subtracting, from the numbers of the array before splitting, the numbers of the split array element by element, the splitting unit generates an array obtained by splitting off a numeric component that represents the most significant digit of the remaining number and transmits the array to the server, and
wherein the server includes a combining unit that, each time an array is received from the client, performs calculation processing using a new array generated by combining, element by element, the numbers of the received array with those of a stored array.

(Supplementary Note 2) The information processing system according to Supplementary Note 1, wherein
the splitting unit of the client splits off an element of a number whose number of appearances exceeds a predetermined criterion from the input array, generates an array composed of the split element, and transmits the array to the server, and
the combining unit of the server stores the received array.

(Supplementary Note 3) The information processing system according to Supplementary Note 1 or 2, wherein the combining unit of the server causes an Ising machine on the cloud to execute calculation processing.

(Supplementary Note 4) The information processing system according to any one of Supplementary Notes 1 to 3, wherein the splitting unit of the client transmits, to the server, an array generated by splitting the number of each element of the array one bit at a time from the most significant digit.

(Supplementary Note 5) The information processing system according to any one of Supplementary Notes 1 to 4, wherein the splitting unit of the client transmits, to the server, an array represented as a product of a value obtained by dividing a difference between a maximum value and a minimum value of numbers of elements of the array by a power of two that increases with each division of the array, and a matrix represented by two values of 0 and 1.

(Supplementary Note 6) The information processing system according to any one of Supplementary Notes 1 to 4, wherein the splitting unit of the client transmits, to the server, an array represented as a product of a matrix indicating the sign of each element of the array, a value obtained by dividing a maximum absolute value of the elements by a power of two that increases with each division of the array, and a matrix represented by two values of 0 and 1.

(Supplementary Note 7) The information processing system according to any one of Supplementary Notes 1 to 4, wherein the splitting unit of the client transmits, to the server, an array represented as a product of a matrix indicating the sign of each element of the array, a value obtained by dividing a difference between a maximum absolute value and a minimum absolute value of the elements by a power of two that increases with each division of the array, and a matrix represented by two values of 0 and 1.

(Supplementary Note 8) The information processing system according to Supplementary Note 3, wherein the combining unit of the server terminates the calculation processing when a calculation result obtained by the Ising machine has converged.

(Supplementary Note 9) The information processing system according to any one of Supplementary Notes 1 to 8, wherein the combining unit of the server terminates the calculation processing when a preset calculation time has been reached.

(Supplementary Note 10) An array splitting device comprising:
a transceiver unit that performs transmission and reception with a server that, each time an array whose elements are numbers is received, performs calculation processing using a new array generated by combining, element by element, the numbers of the received array with those of a stored array; and
a splitting unit that, for each element of an input array whose elements are numbers, generates an array obtained by splitting off a numeric component that represents the most significant digit of the number and transmits the array to the server, and then repeats processing in which, for a number remaining for each element after subtracting, from the numbers of the array before splitting, the numbers of the split array element by element, the splitting unit generates an array obtained by splitting off a numeric component that represents the most significant digit of the remaining number and transmits the array to the server.

(Supplementary Note 11) An array combining device comprising:
a transceiver unit that performs transmission and reception with a client that, for each element of an input array whose elements are numbers, generates and transmits an array obtained by splitting off a numeric component that represents the most significant digit of the number; and
a combining unit that, each time an array is received from the client, performs calculation processing using a new array generated by combining, element by element, the numbers of the received array with those of a stored array,
wherein the client repeats processing in which, for a number remaining for each element after subtracting, from the numbers of the array before splitting, the numbers of the split array element by element, the client generates an array obtained by splitting off a numeric component that represents the most significant digit of the remaining number and transmits the array.

(Supplementary Note 12) An information processing method comprising:
a client, which issues an execution instruction to another computer, generating, for each element of an input array whose elements are numbers, an array obtained by splitting off a numeric component that represents the most significant digit of the number and transmitting the array to a server;
the server, each time an array is received from the client, performing a calculation using a new array generated by combining, element by element, the numbers of the received array with those of a stored array; and
the client repeating processing in which, for a number remaining for each element after subtracting, from the numbers of the array before splitting, the numbers of the split array element by element, generating an array obtained by splitting off a numeric component that represents the most significant digit of the remaining number and transmits the array to the server.

(Supplementary Note 13) An array splitting method comprising:
performing transmission and reception with a server that, each time an array whose elements are numbers is received, performs calculation processing using a new array generated by combining, element by element, the numbers of the received array with those of a stored array; and
generating, for each element of an input array whose elements are numbers, an array obtained by splitting off a numeric component that represents the most significant digit of the number and transmitting the array to the server, and then repeating processing in which, for a number remaining for each element after subtracting, from the numbers of the array before splitting, the numbers of the split array element by element, generating an array obtained by splitting off a numeric component that represents the most significant digit of the remaining number and transmitting the array to the server.

(Supplementary Note 14) An array combining method comprising:
performing transmission and reception with a client that, for each element of an input array whose elements are numbers, generates and transmits an array obtained by splitting off a numeric component that represents the most significant digit of the number; and
a combining unit that, each time an array is received from the client, performing calculation processing using a new array generated by combining, element by element, the numbers of the received array with those of a stored array; and
wherein the client repeats processing in which, for a number remaining for each element after subtracting, from the numbers of the array before splitting, the numbers of the split array element by element, the client generates an array obtained by splitting off a numeric component that represents the most significant digit of the remaining number and transmits the array.

(Supplementary Note 15) An array splitting program that causes a computer to execute:
a transceiver process with a server that, each time an array whose elements are numbers is received, performs calculation processing using a new array generated by combining, element by element, the numbers of the received array with those of a stored array; and
a splitting process that, for each element of an input array whose elements are numbers, generates an array obtained by splitting off a numeric component that represents the most significant digit of the number and transmits the array to the server, and then repeats processing in which, for a number remaining for each element after subtracting, from the numbers of the array before splitting, the numbers of the split array element by element, and that generates an array obtained by splitting off a numeric component that represents the most significant digit of the remaining number and transmits the array to the server.

(Supplementary Note 16) An array combining program that causes a computer to execute:
a transceiver process with a client that, for each element of an input array whose elements are numbers, generates and transmits an array obtained by splitting off a numeric component that represents the most significant digit of the number; and
a combining process that, each time an array is received from the client, performs calculation processing using a new array generated by combining, element by element, the numbers of the received array with those of a stored array,
wherein the client repeats processing in which, for a number remaining for each element after subtracting, from the numbers of the array before splitting, the numbers of the split array element by element, the client generates an array obtained by splitting off a numeric component that represents the most significant digit of the remaining number and transmits the array.

While the present disclosure has been described with reference to the example embodiments and examples above, the present disclosure is not limited to the above-described embodiments and examples. Various modifications to the configuration and details of the present disclosure can be made by those skilled in the art within the scope of the present disclosure.

The present disclosure is suitably applicable to an information processing system that causes another computer to execute processing. For example, the information processing system of the present disclosure can be suitably applied to a case where a combinatorial optimization problem is solved by an Ising machine on a cloud.

1. An information processing system comprising:
a client that issues an execution instruction to another computer; and
a server that receives the execution instruction from the client,
wherein the client, for each element of an input array whose elements are numbers, generates an array obtained by splitting off a numeric component that represents the most significant digit of the number and transmits the array to the server, and then repeats processing in which, for a number remaining for each element after subtracting, from the numbers of the array before splitting, the numbers of the split array element by element, generates an array obtained by splitting off a numeric component that represents the most significant digit of the remaining number and transmits the array to the server, and
wherein the server, each time an array is received from the client, performs calculation processing using a new array generated by combining, element by element, the numbers of the received array with those of a stored array.

2. The information processing system according to claim 1, wherein
the client splits off an element of a number whose number of appearances exceeds a predetermined criterion from the input array, generates an array composed of the split element, and transmits the array to the server, and
the server stores the received array.

3. The information processing system according to claim 1, wherein
the server causes an Ising machine on the cloud to execute calculation processing.

4. The information processing system according to claim 1, wherein
the client transmits, to the server, an array generated by splitting the number of each element of the array one bit at a time from the most significant digit.

5. The information processing system according to claim 1, wherein
the client transmits, to the server, an array represented as a product of a value obtained by dividing a difference between a maximum value and a minimum value of numbers of elements of the array by a power of two that increases with each division of the array, and a matrix represented by two values of 0 and 1.

6. An array splitting device comprising:
a memory storing instructions; and
one or more processors configured to execute the instructions to:
perform transmission and reception with a server that, each time an array whose elements are numbers is received, performs calculation processing using a new array generated by combining, element by element, the numbers of the received array with those of a stored array; and
generate, for each element of an input array whose elements are numbers, an array obtained by splitting off a numeric component that represents the most significant digit of the number and transmit the array to the server, and then repeat processing in which, for a number remaining for each element after subtracting, from the numbers of the array before splitting, the numbers of the split array element by element, generate an array obtained by splitting off a numeric component that represents the most significant digit of the remaining number and transmit the array to the server.

7. An array combining device comprising:
a memory storing instructions; and
one or more processors configured to execute the instructions to:
perform transmission and reception with a client that, for each element of an input array whose elements are numbers, generates and transmits an array obtained by splitting off a numeric component that represents the most significant digit of the number; and
perform, each time an array is received from the client, calculation processing using a new array generated by combining, element by element, the numbers of the received array with those of a stored array,
wherein the client repeats processing in which, for a number remaining for each element after subtracting, from the numbers of the array before splitting, the numbers of the split array element by element, the client generates an array obtained by splitting off a numeric component that represents the most significant digit of the remaining number and transmits the array.
